(19) United States
(12) Patent Application Publication
(10) Pub. No.: US 2008/0122571 A1
(43) Pub. Date: May 29, 2008

(54) FULGURITE REDUCING FUSE

(75) Inventors: Daniel G. BUCHANAN, Vestal, NY (US); Glenn E. WILSON, Endicott, NY (US); William J. WRIGHT, Deposit, NY (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: EMERSON ELECTRIC CO., St. Louis, MO (US)

(21) Appl. No.: 11/943,807

(22) Filed: Nov. 21, 2007

Related U.S. Application Data
(60) Provisional application No. 60/867,542, filed on Nov. 28, 2006.

(51) Int. Cl. H01H 85/18

(52) U.S. Cl. 337/276

(57) ABSTRACT

The present disclosure provides an improved system and method that reduces fulgurites and their effects in a fuse. The fuse element can be at least partially coated with a high temperature elastomeric compound, such as a silicone, that can substantially withstand the heat of the current sufficient to “blow” the fuse and associated arcing, if any, and not allow the local melting of the sand to form the fulgurite. Thus, the elastomeric compound shields the sand from the arcing. The arcing can be suppressed faster by not allowing fulgurites to form near the arc to provide a channel for the arc. The arc can be suppressed quicker with less heat without the channel. In general, if a fulgurite is formed, it is formed near the beginning of the elastomeric coating that is distal from another part of the exposed fuse such that arcing, if any, is reduced.

### CROSS REFERENCE TO RELATED APPLICATIONS

This application claims the benefit of U.S. Provisional Application No. 60/867,542 filed Nov. 28, 2006.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO APPENDIX

Not applicable.

### BACKGROUND

1. Field of the Invention

The invention relates to electrical protection devices. More specifically, the invention relates to electrical fuses.

2. Description of Related Art

For many years, companies have made electrical fuses with various fuse elements such as copper or silver to conduct a rated current through the fuse. These conductive elements may be made in many different shapes, sizes, and lengths. Some elements are designed for 120 VAC to 600 VAC. These typically have longer fuse links. Automotive fuses designed for 13.6 VDC often have thicker elements leading to a narrower center section.

When a fuse “blows” to create an open circuit, it does so when an excess current is flowing that exceeds the rated capacity of the fuse element. Despite the ostensibly “open” circuit, an arc develops across the section where the element opened during the current flow. The current continues to flow through this arc as long as it can. The arc is not desirable due to the extreme temperatures developed from the power being dissipated, that is, the power from the current through the arc and voltage across the arc.

Usually, the fuse element is surrounded by air to lower manufacturing costs. However, to minimize the above arcing upon the element, the element is often surrounded by silica sand. This sand helps quench the arc in medium-energy situations. In high-energy situations, a “fulgurite” forms around the link in the sand. “Fulgurite” is the varietal name given to quartz, Si0₂, which has been fused by intense arcing, such as lightning striking the Earth or the fuse arcing described above, where the quartz is locally melted. The best known fulgurites are found in quartz sands, where the fulgurites take the form of tubes. In fuses, the fulgurite is a tunnel through the sand that allows the arc to continue conducting current—exactly what the sand was supposed to keep from happening.

Thus, there remains a need to reduce the effect of fulgurites and the undesired arcing.

### BRIEF SUMMARY

The present disclosure provides an improved system and method that reduces fulgurites and their effects in a fuse. The fuse element can be at least partially coated with a high temperature elastomeric compound that can substantially withstand the heat of the current sufficient to “blow” the fuse and associated arcing, if any, and not allow the local melting of the sand to form the fulgurite. Thus, the elastomeric compound shields the sand from the arcing. The arcing can be suppressed faster by not allowing fulgurites to form near the arc to provide a channel for the arc. The arc can be suppressed quicker with less heat without the channel. In at least one embodiment, the elastomeric compound can be a high temperature silicone, such as a “room temperature vulcanizing” (RTV) silicone. In general, if a fulgurite is formed, it is formed near the beginning of the elastomeric coating that is distal from another part of the exposed fuse such that arcing, if any, is reduced.

The disclosure provides a fuse, comprising: a fuse body; a fuse element disposed inside the body; a filler disposed inside the body and around a portion of the element; and a means for reducing fulgurite formation along a portion of the length of the fuse element.

The disclosure also provides a fuse, comprising: a fuse body; a fuse element disposed inside the body; a filler disposed inside the body and around a portion of the element; and an elastomeric sheath disposed around a portion of a length of the element.

The disclosure also provides a method of reducing fulgurite formation in a fuse having a fuse element disposed therein, comprising: surrounding at least a portion of the element with an elastomeric sheath; and surrounding at least a portion of the element and the sheath with a filler.

### BRIEF DESCRIPTION OF THE DRAWINGS

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art as required by 35 U.S.C. §112.

FIG. 1 is a cross-sectional schematic side diagram of an exemplary fuse according the present invention.

FIG. 2 is a cross-sectional schematic end diagram of the exemplary fuse of FIG. 1.

### DETAILED DESCRIPTION

One or more illustrative embodiments incorporating the invention disclosed herein are presented below. Not all features of an actual implementation are described or shown in this application for the sake of clarity. It is understood that the development of an actual embodiment incorporating the present invention, numerous implementation-specific decisions must be made to achieve the developer's goals, such as compliance with system-related, business-related, and other constraints, which vary by implementation and from time to time. While a developer's efforts might be complex and time-consuming, such efforts would be, nevertheless, a routine undertaking for those of ordinary skill in the art having benefit of this disclosure.

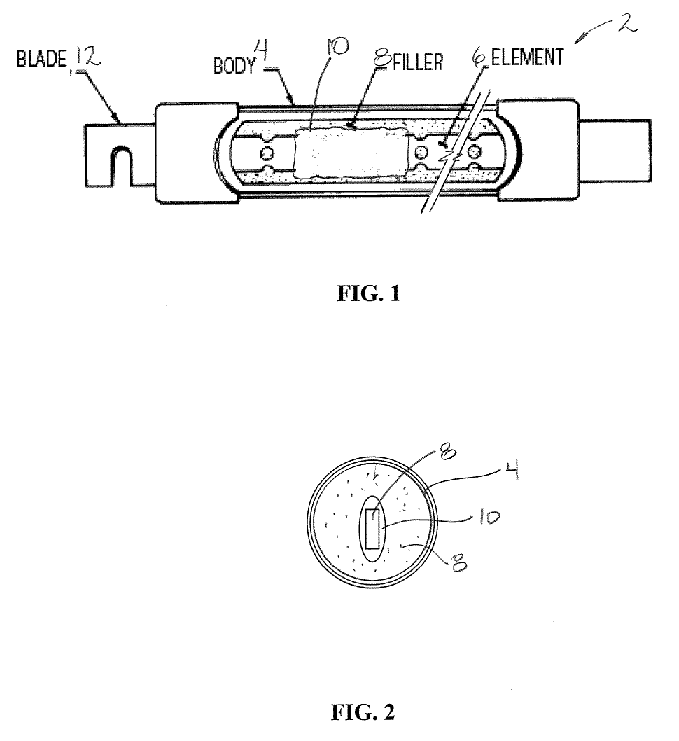

FIG. 1 is a cross-sectional schematic side diagram of an exemplary fuse according the present invention. FIG. 2 is a cross-sectional schematic end diagram of the exemplary fuse of FIG. 1. FIGS. 1 and 2 will be described in conjunction with each other. A fuse 2 generally includes a body 4 with an element 6 enclosed therein. The element 6 is generally welded or soldered to the ends of the fuse that make contact with the circuit (not shown) to be protected. The shape, size, and mass of the fuse element and its materials determine the electrical and thermal characteristics of the fuse and its protective capacity. The heat generated through the fuse element 6 is dependent upon its resistance and current flowing through the element. Some heat is absorbed by a filler 8 that surrounds the element 6. The filler 8 can be, for example, silica sand or simple play sand, super fine grain or coarser grain. The filler conducts the heat to the external portions of the fuse for dissipation to the ambient environment. A high current load, such as a short circuit, causes an excess heat that cannot be dissipated quickly. The excess heat reaches the melting point of the element and the element melts at some portion along its length, causing the fuse to “blow” to create a non-conducting open circuit.

While a portion of the element 6 can surrounded by the filler 8, another portion of the element 6 is surrounded by an elastomeric sheath 10, described below. The fuse can also include one or more connectors 12 to help ensure physical and conductive connection to a circuit (not shown) to be protected.

In at least one embodiment, the sheath 10 is generally located toward the middle of the element 6, because most fuses “open” in the middle of the element, but can extend the entire length of the element. The sheath includes a variety of elastomeric compounds that can function at operating temperatures of fuses and the elements. For example and without limitation, the elastomeric sheath can be a silicone. Silicones offer good long-term resistance to environmental extremes such as from −160° F. to 600° F. Further, silicones have a low flammability rating and do not support or promote flame. More specifically in at least one embodiment, the sheath 10 can be formed from “room temperature vulcanizing” (RTV) silicone. RTV silicone compositions generally include from about 10 to about 98 weight percent (based on the total weight of the RTV silicone composition) of polydiorganosiloxanes, wherein the “organo” can be a number of functional groups, including hydroxysilyl groups, alkoxysiliyl, multi-alkoxysilyl groups, and so forth. Viscosities can range from about 0.5 to 5,000 Pa.-sec. at 25° C. dynamic viscosity and up to about 500,000 cSt at 25° C. kinematic viscosity. Further, RTV silicone compounds often contain fillers (silicas, aluminas, iron oxide, calcium carbonate, clays, and other fillers), cure accelerators, and crosslinking agents, such as metal chelates, organic chelators, and the like. They are often, but not always, cross-linked/cross-linkable. Other ingredients that are conventionally used in RTV silicone compositions such as adhesion promoters, rheology additives, fungicides, colorants, pigments, and plasticizers can be added as long as they do not interfere with the desired properties of the end product. Structurally, they are organopolysiloxanes, which can be synthesized by a variety of known procedures. Some RTV silicone rubber compositions can cure to a transparent elastomer having a high elasticity/rubber strength. While it is believed that any commercially available (and others) RTV silicone compositions would work, in practice the system has been found to work with a GE brand product known as “White Blanc RTV 162 Silicone Rubber Adhesive Sealant.”

Although the length and thickness of the sheath 10 can vary along the length of the fuse element 6, the inventors have found a suitable length for the sheath 10 can be between 0.1 inches long to 1.0 inches long, with a non-limiting example being 0.4 inches long. As a further non-limiting example, a practical thickness for the sheath can be up to 0.4 inches thick around the periphery of the element, although other thicknesses can be used. The sheath 10 can be generally located somewhere in the middle of the element 6. Further, the sheath 10 can comprise a plurality of sheaths at multiple locations along the element 6. For some fuses having a plurality of elements, such elements can each contain their own sheath or a combined sheath over two or more of the plurality of the elements. A sheath over two or more of the plurality of elements is especially useful if the elements are disposed adjacent each other.

The invention has been described in the context of preferred and other embodiments and not every embodiment of the invention has been described. Apparent modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intends to protect all such modifications and improvements to the full extent that such falls within the scope or range of equivalent of the following claims.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described herein for clarity in reference to the figures and are not to be limiting of the actual device or system or use of the device or system. Unless the context requires otherwise, the word “comprise” or variations such as “comprises” or “comprising”, should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

Further, any references mentioned in the application for this patent as well as all references listed in the information disclosure originally filed with the application are hereby incorporated by reference in their entirety to the extent such may be deemed essential to support the enabling of the invention. However, to the extent statements might be considered inconsistent with the patenting of the invention, such statements are expressly not meant to be considered as made by the Applicant(s).

### REFERENCES

http://www.minresco.com/fulgurites/fulgurites.htm

1. A fuse, comprising:
a fuse body;
a fuse element disposed inside the body;
a filler disposed inside the body and around a portion of the element; and
a means for reducing fulgurite formation along a portion of the length of the fuse element.

2. The fuse of claim 1, wherein the means for reducing fulgurite formation comprises an elastomeric sheath disposed around a portion of a length of the element.

3. The fuse of claim 2, further comprising a plurality of elastomeric sheaths disposed along a length of the element.

3. The fuse of claim 1, wherein the element and the means for reducing fulgurite formation are surrounded by the filler.

4. The fuse of claim 1, wherein the element comprises silver, copper, lead, or a combination thereof.

5. The fuse of claim 1, wherein the element comprises a low-temperature alloy.

6. The fuse of claim 1, further comprising a plurality of fuse elements and at least a portion of the plurality of fuse elements having the means for reducing fulgurite formation.

7. The fuse of claim 6, further comprising two or more elastomeric sheaths disposed around two or more of the plurality of elements.

8. The fuse of claim 6, further comprising an elastomeric sheath disposed around two or more of the plurality of elements.

9. The fuse of claim 1, wherein the means for reducing fulgurite formation comprises a silicone.

10. A fuse, comprising:
a fuse body;
a fuse element disposed inside the body;
a filler disposed inside the body and around a portion of the element; and
an elastomeric sheath disposed around a portion of a length of the element.

11. The fuse of claim 10, further comprising a plurality of fuse elements and at least a portion of the plurality of fuse elements being surrounded by the sheath.

12. The fuse of claim 11, further comprising two or more elastomeric sheaths disposed around two or more of the plurality of elements.

13. The fuse of claim 1, wherein the sheath comprises a silicone.

14. A method of reducing fulgurite formation in a fuse having a fuse element disposed therein, comprising:
surrounding at least a portion of the element with an elastomeric sheath; and
surrounding at least a portion of the element and the sheath with a filler.

15. The method of claim 14, further comprising isolating the portion of the element surround by the sheath from the filler.

16. The method of claim 14, wherein the sheath comprises a silicone.

16. The method of claim 14, wherein the fuse comprises a plurality of elements and the sheath surrounds at least a portion of the plurality of elements along their lengths.

17. The method of claim 14, wherein the fuse comprises a plurality of elements and a plurality of sheaths surround at least a portion of the plurality of elements along their lengths.
